(19) United States
(12) Patent Application Publication
(10) Pub. No.: US 2011/0153748 A1
(43) Pub. Date: Jun. 23, 2011

(54) REMOTE FORENSICS SYSTEM BASED ON NETWORK

(75) Inventors: Joo Young Lee, Daejeon (KR); Sung Kyong Un, Daejeon (KR); Young Soo Kim, Seoul (KR); Geon Woo Kim, Daejeon (KR); Sang Su Lee, Daejeon (KR); Su Hyung Jo, Daejeon (KR); Youn Hee Gil, Daejeon (KR); Woo Yong Choi, Daejeon (KR); Do Won Hong, Daejeon (KR); Hyun Sook Cho, Daejeon (KR)

(73) Assignee: ELECTRONICS AND TELECOMMUNICATIONS RESEARCH INSTITUTE, Daejeon (KR)

(21) Appl. No.: 12/971,177

(22) Filed: Dec. 17, 2010

(30) Foreign Application Priority Data
Dec. 18, 2009 (KR) 10-2009-0127544
Jun. 1, 2010 (KR) 10-2010-0052027
Nov. 3, 2010 (KR) 10-2010-0108730

(51) Int. Cl. G06F 15/16

(52) U.S. Cl. 709/205

(57) ABSTRACT

A remote forensics system based on a network is provided to allow for accessing a forensics analysis center from a remote area to perform forensic analysis. The network-based remote forensic system includes: one or more remote terminals performing forensic analysis on an evidence device in a remote area, through a virtual forensic tool when the evidence device is connected thereto; and an investigation center system connected to the remote terminals via a wide area network to provide the virtual forensic tool, processing a requirement of the remote terminals, and providing requirement processing results to the remote terminals.

### CROSS-REFERENCE TO RELATED APPLICATIONS

This application claims the priority of Korean Patent Application Nos. 10-2009-0127544 filed on Dec. 8, 2009, 10-2010-0052027 filed on Jun. 1, 2010 and 10-2010-0108730 filed on Nov. 3, 2010, in the Korean Intellectual Property Office, the disclosures of which are incorporated herein by reference.

### BACKGROUND OF THE INVENTION

1. Field of the Invention

The present invention relates to an apparatus for performing forensics analysis in a digital manner and, more particularly, to a remote forensics system based on a network allowing for access to a forensics analysis center from a remote area to perform forensic analysis.

2. Description of the Related Art

In the related art, in order to perform a digital forensic analysis, pieces of evidence are seized from the scene of a crime and brought into a forensic analysis center or a mobile forensic toolkit about the size of a briefcase is brought into the crime scene in order to analyze the scene of the crime.

However, as the number of digital mediums used in diverse crimes, as well as IT-related crimes, increases, the amount of data to be analyzed is drastically increased while a device and system for analyzing the pieces of evidence secured from the scene must be physically moved from the scene to the forensic analysis center and a forensic system is accessed to analyze the pieces of evidence. Thus, a huge amount of temporal and monetary costs are incurred due to the movement of evidence, and besides, as there is a limitation in personnel for analyzing the secured pieces of evidence, a great deal of time is wasted to wait for the analysis.

Meanwhile, a mobile forensic toolkit has been proposed, largely to be used to generate an image or secure a volatile piece of data evidence, or the like, on the spot; however, the mobile forensic toolkit having limited resources is unfit to analyze large capacity data or anti-forensic technique-applied data.

Besides, an agent, or the like, is installed in advance in a system to be monitored and a forensic tool supporting eDiscovery, or the like, serves to monitor the system, generate an image or a snap shot with respect to target data if necessary, and transmit the same to a forensic server system. However, this kind of tool can be applicable to an environment in which the system to be monitored must be defined in advance and the agent is installed in the system.

The requirements for the functions and resources of a forensic system are increasing to cope with the increase in the capacity of data to be analyzed and the development of an anti-forensic technique. Thus, forensic analysis centers equipped with advanced facilities available for quickly processing large capacity data, such as establishing a forensic system in the form of a laboratory or additionally installing high-priced hardware equipment, are opened.

However, because such forensic analysis center requires a great deal of costs for facilities, the facilities can be provided to only one or two places within a major area, so another area is not available for a forensic analysis or must deliver an analysis target evidence to the center and then receive the corresponding results through a complicated process.

In addition to the cost factors incurred for data collection, transmission and analysis in the existing digital forensic procedure, there are various problems and inconveniences in using the existing tools. With the existing tools, only an expert or a person who is skilled in the usage of a particular tool can obtain desired information, and it is never easy to learn how to use the tools to a level that even certification as a tool usage expert is granted. In this situation, a layman or a beginner could not obtain the same results as an expert while using the same tools.

Also, in most cases, beginners tend not to know what should be searched for and which functions they can use, and are not clear as to exactly what they want to search for, and in this case, the existing tools cannot help find a clue and do not provide any alternative. This may force an investigator to make great efforts to use the forensic tool, rather than focusing on the substance of the investigation, degrading the utilization of the digital forensic tool.

In addition, the existing forensic tools are focused on allowing for searching for intended content to merely obtain fragmentary information, while making it difficult to recognize the connection or association between different types of information. The recognition of the connection or association between different types of information relies on the investigators thereof, so the existing forensic tools are therefore disadvantageous, in that even in the case the same tools and data are used, the same results may not be obtained, depending on investigative experience and know-how.

As described above, the related art digital forensic methods have various limitations in effectively analyzing large quantity data within a short time.

FIG. 1 is a schematic block diagram of the related art digital forensic device.

With reference to FIG. 1, the related art digital forensic device 100 is implemented as a single device including an image generation unit 101, a storage device 102, an analyzing unit 103, a searching unit 104, an output unit 105, and a writing prevention device 120.

When an evidence device 110 (e.g., a hard disk, a physical memory, a solid state driver (SSD), and the like) brought as an evidence into a forensic analysis center is connected to the writing prevention device 120, the image generation unit 101 generates a forensic image by using a data stream read by the writing prevention device 120 and stores the same in the storage device 102.

Then, the analyzing unit 103 may analyze each file attribute, a timeline, an e-mail account, a log, or the like, with respect to the forensic image, or the searching unit 104 performs query and pattern searching, or the like, on a normal file, a deleted file, and the like, included in the forensic image, and the output unit 105 informs the user about the forensic results through a report or a screen output.

In this manner, when the related art digital forensic device 100 is in use, an analysis target disk or system must be moved to the forensic analysis center to perform imaging or analyzing through the digital forensic device 100 or a mobile system or a memory including the digital forensic device 100 must be directly brought into the scene to perform analyzing.

Then, as mentioned above, time and costs are unnecessarily incurred due to the physical movement, and forensic analysis may be able to be performed by using only the limited resources included in the digital forensic device 100, causing a problem in that the processing capacity and speed of the forensic analysis are limited.

### SUMMARY OF THE INVENTION

An aspect of the present invention provides a network-based remote forensic system allowing any qualified person to access a remote forensic analysis center via a network to perform forensic analysis at any time and in any place, such as at an investigation spot or in another desired place.

An aspect of the present invention provides a network-based remote forensic system capable of utilizing resources included in a distributed environment, a grid environment, a cloud computer environment, or the like, to thus flexibly increase processing capacity and speed.

According to an aspect of the present invention, there is provided a network-based remote forensic system including: one or more remote terminals performing forensic analysis on an evidence device in a remote area, through a virtual forensic tool when the evidence device is connected thereto; and an investigation center system connected to the remote terminals via a wide area network to provide the virtual forensic tool, processing a requirement of the remote terminals, and providing requirement processing results to the remote terminals.

The investigation center system may include: a forensic analysis system processing the requirement of the remote terminals and outputting the requirement processing results; and a forensic server system providing the virtual forensic tool to the remote terminals and relaying data communication between the remote terminals and the forensic analysis system.

The forensic server system may include: a communication unit supporting the connection between the remote terminals and the forensic analysis system and data communication; an access controller controlling an access right of the remote terminals; a virtualization unit providing the virtual forensic tool only when the remote terminals have an access right; and a processor controller supporting multiple accessing of the remote terminals.

The virtualization unit may include: a visualization module visualizing a user interface supporting forensic analysis and the forensic processing results and providing the same; and a virtual file system module parsing and managing the structure of a file system included in a forensic image.

The forensic analysis system may include: a communication unit supporting a connection to the forensic server system and data communication; an image generation unit generating a forensic image by using a data stream from the remote terminals transmitted through the forensic server system, and storing the same; an analyzing unit analyzing a piece of evidence by using the forensic image; a searching unit performing evidence searching by using the forensic image; and a process controller controlling the operation of the image generation unit, the analyzing unit, and the searching unit according to a request message from the remote terminals transmitted via the forensic server system, and transmitting the control results to the remote terminals via the forensic server system.

The investigation center system may include: an extendable forensic server system connected to the remote terminals to provide the virtual forensic tool, processing a requirement of the remote terminals, and providing requirement processing results to the remote terminals; and a lab/distributed system providing resources required for the operation of the extendible forensic server system.

The extendible forensic server system may include: a communication unit supporting a connection to the remote terminals and data communication; an access controller controlling an access right of the remote terminals; a virtualization unit providing the virtual forensic tool only when the remote terminals have an access right; an image generation unit generating a forensic image by using a data stream from the remote terminals and storing the same; an analyzing unit analyzing a piece of evidence by using the forensic image; a searching unit performing evidence searching by using the forensic image; and a process controller controlling the operation of the image generation unit, the analyzing unit, and the searching unit according to a request message from the remote terminals, and transmitting the control results to the remote terminals.

The extendible forensic server system may include: a server function unit supporting communication with the remote terminals, and providing the virtual forensic tool to the remote terminals; a data input unit converting a data format of multi-source data into an internal format and generating a forensic image; a data processing unit performing evidence searching and analyzing on the forensic image according to a request from the remote terminals; a data output unit providing processing results of the data processing unit to the remote terminals; a data management unit storing data in a storage device or reading the data under the control of the data processing unit and the data output unit; and a digital data evidencing unit performing evidencing on the data input from the remote terminals and data provided from the remote terminals.

The extendible forensic server system may provide a forensic service in a cloud computing manner.

The server function unit may include: a communication unit supporting a connection to the remote terminals and data communication; an access controller controlling an access right of the remote terminals; a virtualization unit providing the virtual forensic tool only when the remote terminals have an access right; and a processor controller supporting multiple accessing of the remote terminals.

The data input unit may include: a multi-source data acquiring/converting unit standardizing a data format of input data having multiple sources into an internal format; and an image generation unit generating a forensic image with respect to an output from the multi-source data acquiring/converting unit.

The data output unit may include: a data visualization unit providing operation results of the data processing unit, as visualized data; and a reporting unit providing the operation results of the data processing unit in the form of a report.

The extendible forensic server system may further include: a profile management unit managing and providing a profile with respect to a category of each case (or event).

The profile management unit may include: a log recording unit recording a user log in a memory; a log filter unit mapping a case category to the user log and selecting only a valid log; a connection analyzing unit extracting an analysis pattern of each function and case from the valid log and analyzing their connection; and a profile generating and updating unit generating or updating a profile with respect to a category of each case according to the results of the connection analysis.

The data management unit may further have a function of merging two or more cases or a portion of a case as a new case by using the data stored in the storage device.

The case may include: a meta data area in which one or more of a case name, a generation date/time, a generator are indicated; a case data identifying area in which one or more of the path of data or a data set, a physical address, and a URI are indicated; and a function permission set area defining a function that can be performed with respect to the data or the data set within an applied range.

The case may be provided to the remote terminals according to a forensic cloud service method.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of the related art digital forensic device;

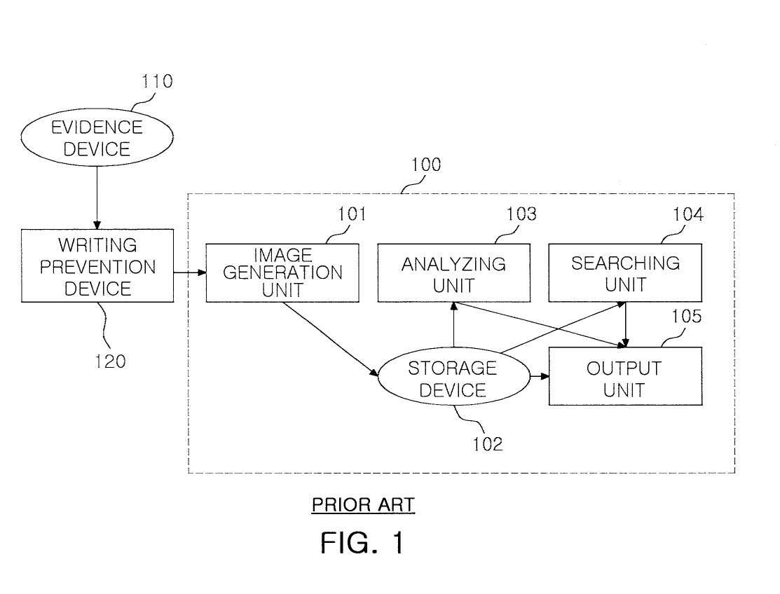

FIG. 2 is a schematic block diagram of a network-based remote forensic system according to an exemplary embodiment of the present invention;

FIG. 3 is a detailed block diagram of a forensic server system according to an exemplary embodiment of the present invention;

FIG. 4 is a block diagram of a virtualization unit according to an exemplary embodiment of the present invention;

FIG. 5 is a detailed block diagram of a forensic analysis system according to an exemplary embodiment of the present invention;

FIG. 6 is a schematic block diagram of a network-based remote forensic system according to another exemplary embodiment of the present invention;

FIG. 7 is a detailed block diagram of an extendable forensic server system according to another exemplary embodiment of the present invention;

FIG. 8 is a schematic block diagram of a network-based remote forensic system according to another exemplary embodiment of the present invention;

FIG. 9 is a detailed block diagram of an extendable cloud computing system according to another exemplary embodiment of the present invention;

FIG. 10 is a view showing the concept of a forensic cloud service provided by the network-based remote forensic system according to another exemplary embodiment of the present invention;

FIG. 11 is a view showing the example of a configuration and operation of the network-based remote forensic system according to another exemplary embodiment of the present invention;

FIG. 12 is a view showing a case structure according to an exemplary embodiment of the present invention;

FIG. 13 is a view showing an example of merging and extracting cases according to an exemplary embodiment of the present invention; and

FIG. 14 is a detailed block diagram of a profile management unit according to another exemplary embodiment of the present invention.

### DETAILED DESCRIPTION OF THE PREFERRED EMBODIMENT

The present invention may be modified variably and may have various embodiments, particular examples of which will be illustrated in drawings and described in detail.

However, it should be understood that the following exemplifying description of the invention is not intended to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any item from among the plurality of related items disclosed.

When a component is mentioned as being “connected” to or “accessing” another component, this may mean that it is directly connected to or accessing the other component, but it is to be understood that another component may exist therebetween. On the other hand, when a component is mentioned as being “directly connected” to or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context in which it is used. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Embodiments of the present invention will be described below in detail with reference to the accompanying drawings, where those components are rendered using the same reference number that are the same or are in correspondence, regardless of the figure number, and redundant explanations are omitted.

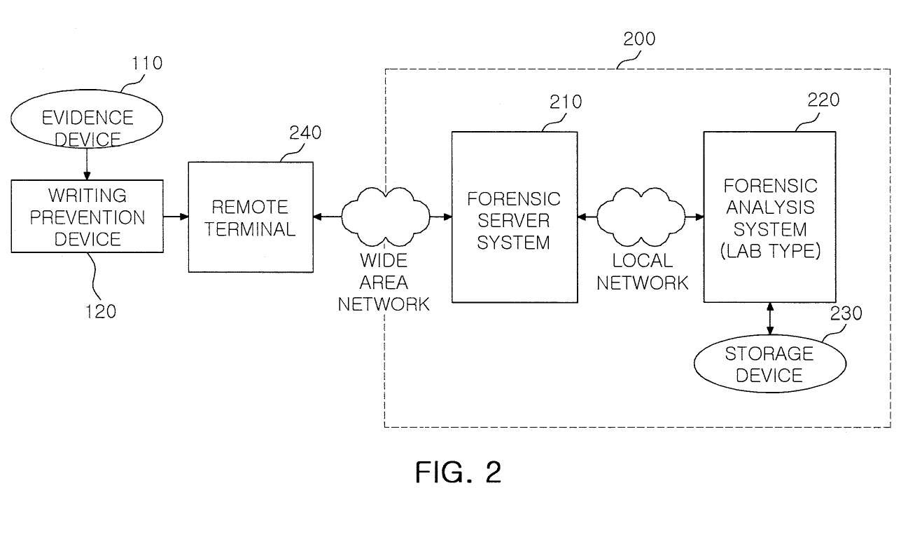

FIG. 2 is a schematic block diagram of a network-based remote forensic system according to an exemplary embodiment of the present invention.

With reference to FIG. 2, a network-based remote forensic system may include an investigation center system 200 and a remote terminal 240 connected to the investigation center system 200 via a wide area network. The investigation center system 200 may include a forensic server system 210, a forensic analysis system 220, and a storage device 230. The network-based remote forensic system may further include a writing prevention device 120 in order to prevent content stored in an evidence device 110, i.e., evidence, from being abnormally manipulated.

The forensic server system 210 and the forensic analysis system 220 may be connected via a local network established in a forensic analysis center, and the forensic server system 210 and the remote terminal 240 may be connected via a wide area network. In order to maximize system utilization, a plurality of forensic analysis systems 220 may interwork with the forensic server system 210 and used.

Functions of the respective elements will now be described.

The remote terminal 240 may be any one of an electronic device, such as a computer, a Web book, a mobile phone, a smartphone, or the like, available for data communication using a network. The remote terminal 240 may receive a virtual forensic tool from the forensic server system 210 to allow an investigator present in a remote area (e.g., at an investigation scene) to perform forensic analysis by using a virtual forensic tool.

The virtual forensic tool may be provided in the form of a servlet, and forensic analysis using the virtual forensic tool may be substantially performed through a requesting and responding process between the remote terminal 240 and the forensic server system 210.

The forensic server system 210 supports a connection with the remote terminal 240 located at the scene and data communication, and when the remote terminal 240 is connected, the forensic server system 210 provides a virtual forensic tool to the remote terminal 240. When various demands are generated for forensic analysis by the investigator by using the virtual forensic tool, the forensic server system 210 invokes the forensic analysis system 220 to process the corresponding demands and transmits the processing results to the remote terminal 240. Namely, the forensic server system 210 relays data communication between the remote terminal 240 and the forensic analysis system 220.

An investigator present in the scene of a crime may perform forensic analysis through the remote terminal 240 located at the scene of the crime, without having to bring evidence to a forensic analysis center or bring a forensic toolkit to the scene, unlike in the case of the related art.

The forensic analysis system 220 has a similar structure as that of the related art for forensic device, and additionally provides a communication function and a process control function. Namely, unlike the related forensic device, the forensic analysis system 220 performs a connection to the forensic server system 210. The forensic analysis system 210 may generate or store a forensic image (i.e., a copy of the evidence device 110, as evidence acquired by the investigator) by using a data stream provided via the forensic server system 210, or may perform analysis and searching on a forensic image in response to a request from the remote terminal 240, and provide the processing results to the remote terminal 240 via the forensic server system 210.

The storage device 230 stores and manages various types of information required for forensic under the control of the forensic analysis system 220. The storage device 230 may be installed within the forensic analysis system 220 or may be separately provided at an outer side of the forensic analysis system 220 according to a system implementation environment.

A method for operating the network-based remote forensic system according to an exemplary embodiment of the present invention will now be described.

When the investigator arrives at the scene, secures the remote terminal 240 to be used for an investigation, and is connected to the forensic server system 210, the forensic server system 210 provides a virtual forensic tool to the remote terminal 240 in order to support forensic analysis.

In a state in which the virtual forensic tool is provided, when the investigator connects the evidence device 110 to the remote terminal 240, generates various demands for generating and analyzing a forensic image and performs searching, or the like, by using the virtual forensic tool, the forensic server system 210 receives the demands via the wide area network.

Then, the forensic server system 210 invokes the forensic analysis system 220 to process the demands from the remote terminal 240 and provides the processing results to the remote terminal 240.

In this manner, when the forensic system is established based on the network, the investigator can be connected to the forensic server system located in a remote area via a Web browser, or the like, at the investigation scene or at a desired time and place to use the virtual forensic tool environment provided in the form of a servlet.

As a result, the utilization of the established forensic system can be enhanced, the cost otherwise caused due to the physical distance movement can be reduced, and because evidence is collected at the central forensic center, many investigators can utilize the evidence at any time and in any place, thus increasing work efficiency.

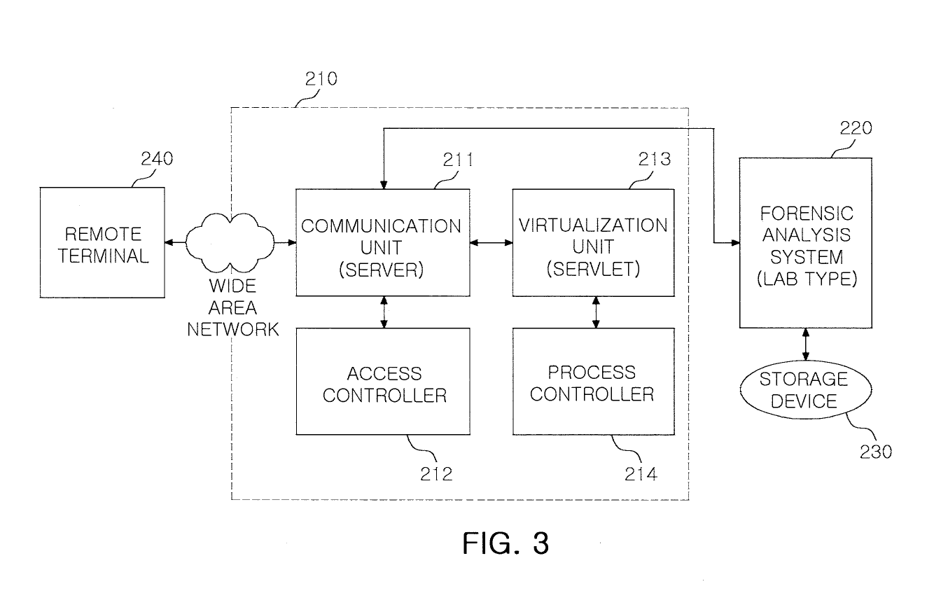

FIG. 3 is a detailed block diagram of a forensic server system according to an exemplary embodiment of the present invention.

With reference to FIG. 3, the forensic server system 210 may include a communication unit 211, an access control unit 212, a virtualization unit 213, and a process controller 214.

The communication unit 211 supports a connection to the remote terminal 240 and data communication, and when the forensic server system 210 is implemented based on a Web, the communication unit 211 drives and manages a Web server. Also, the communication unit 211 supports a connection and data communication with the forensic analysis system 210 connected via a local network within the forensic center. Namely, the communication unit 211 manages an internal network connection with the forensic analysis system 210 as well as a network connection with the remote terminal 240.

The access controller 212 performs an authentication operation using a user ID and password, or the like, to ascertain an access right of the remote terminal 240, and controls an access right of the remote terminal 240 to data and functions according to the ascertaining results.

The virtualization unit 213 provides a virtual forensic tool fitting an access protocol with the remote terminal 240 when the remote terminal 240 has an access right. For example, when the remote terminal 240 is implemented as a terminal such as a PC or the like and is connected by using a Web protocol, the virtualization unit 213 may provide the virtual forensic tool in the form of a servlet. Also, when the remote terminal 240 is a smartphone, the virtualization unit 213 may provide the virtual forensic tool in the form of an application having a forensic function.

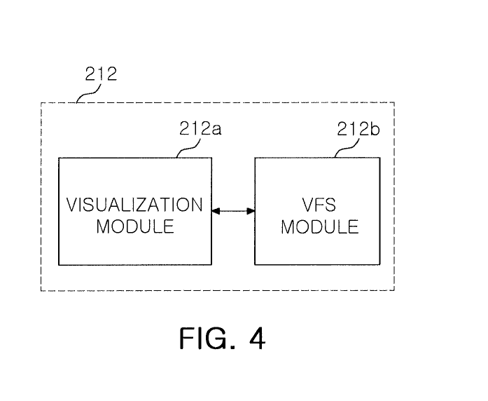

As shown in FIG. 4, the virtualization unit 213 includes a virtualization module 212a virtualizing a user interface supporting forensic analysis, a forensic image, analysis or search results of the forensic analysis, and the like, and providing the same, and a virtual file system (VFS) module 212b parsing the structure of a file system included in the forensic image and managing the same.

The process controller 214 serves to control a system process (not shown) to enable forensic using the virtual forensic tool, although a plurality of investigators are simultaneously connected via the plurality of remote terminals 240.

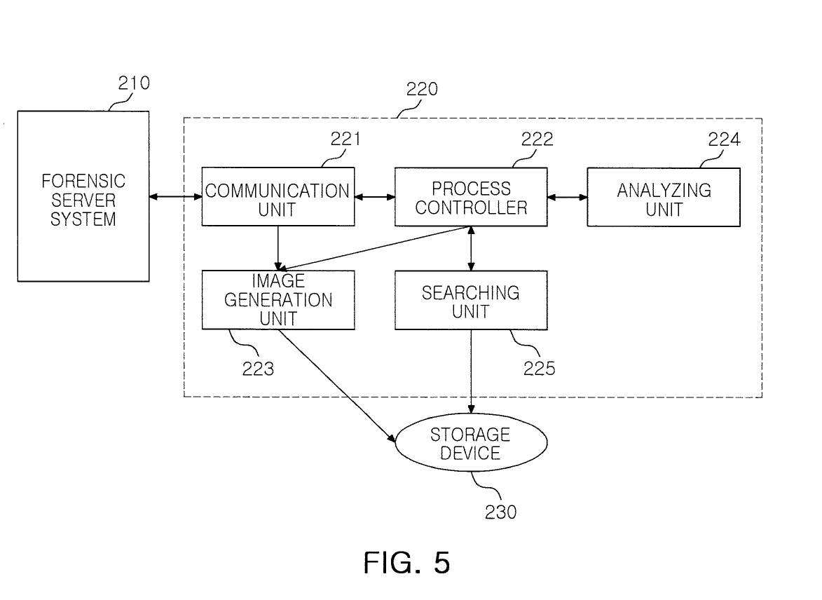

FIG. 5 is a detailed block diagram of a forensic analysis system according to an exemplary embodiment of the present invention.

With reference to FIG. 5, the forensic analysis system 220 may further include a communication unit 221 and a process controller 222 in addition to an image generation unit 223, an analyzing unit 224, a searching unit 225, unlike the related art forensic device.

The communication unit 221 supports a connection and data communication with the forensic server system 210.

The process controller 222 generates and stores a forensic image by controlling the operations of the elements (namely, the image generation unit 223, the analyzing unit 224 and the searching unit 225) according to a data and request message from the remote terminal 240 input via the forensic server system 210, processes analyzing and searching, or the like, on the forensic image, and transmits the processing results to the remote terminal 240 via the forensic server system 210.

The image generation unit 223 generates a forensic image of a copy of the evidence device from a data stream provided from the remote terminal 240, and stores the same in the storage device 230.

In response to the request message from the remote terminal 240, the analyzing unit 224 analyzes file attributes, such as a data type, an extension, a signature, a size, and the like, of the forensic image, and also analyzes a timeline, an e-mail account, a log, and the like. The analyzing unit 224 may provide various analyzing methods for digital forensic analysis, such as a statistics analysis, a timeline analysis, a connection analysis, and the like, besides a registry analysis, an e-mail account analysis, a hidden area analysis, for various storage devices, such as a physical memory, a solid state drive (SSD), and the like, as well as a hard disk drive.

The searching unit 225 performs searching on a normal file, a deleted file, and the like, included in the forensic image with a query, a pattern, and the like, requested by the investigator in response to a request message transmitted from the remote terminal 240. In this case, various searching methods, such as searching by bit stream or by file, index searching, searching of a deleted file and a lost file, etc., may be used.

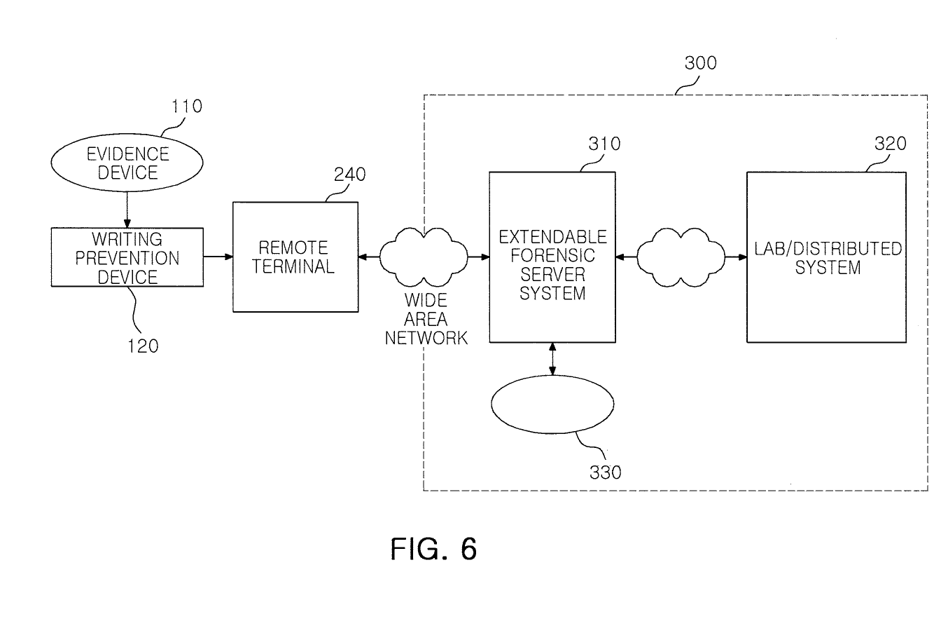

In addition, the network-based remote forensic system according to an exemplary embodiment of the present invention may be implemented by being divided into the foreign server system 210 and the forensic analysis system 220, or the foreign server system 210 and the forensic analysis system 220 may be integrated into a single system. As shown in FIG. 6, the functions of the foreign server system 210 and the forensic analysis system 220 are integrated so as to be implemented as a single system.

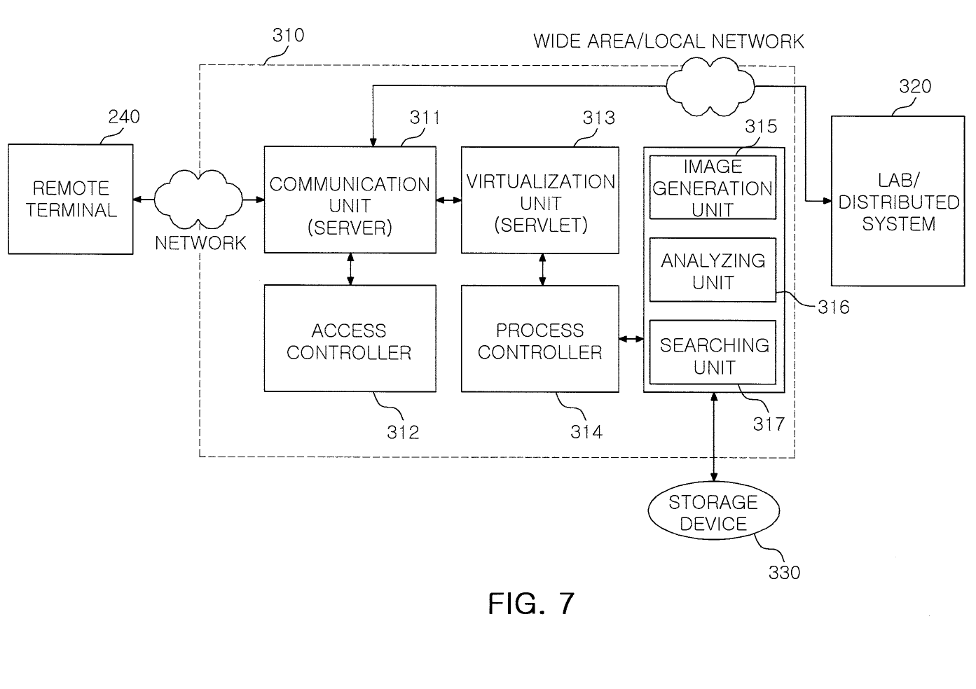

FIGS. 6 and 7 are schematic block diagrams of a network-based remote forensic system according to another exemplary embodiment of the present invention.

With reference to FIG. 6, an investigation center system 300 may be configured as an extendable forensic server system 310 by integrating the functions of the foreign server system 210 and the forensic analysis system 220.

As shown in FIG. 7, the extendable forensic server system 310 includes a communication unit 311, an access controller 312, and a virtualization unit 313 of the forensic server system 210 and an image generation unit 315, an analyzing unit 316 and a searching unit 317 of the forensic analysis system 220 together. The process controller 214 of the forensic server system 210 and the processor controller 222 of the forensic analysis system 220 are integrated into a single processor controller 314 in the extendable forensic server system 310.

Namely, the processor controller 314 of the extendable forensic server system 310 controls the operation of the image generation unit 315, the analyzing unit 316, and the searching unit 317 according to a request message transmitted from the remote terminal 240 and transmits the control results to the remote terminal 240. In addition, although a plurality of investigators are simultaneously connected via the plurality of remote terminals 240, the processor controller 314 controls a system processor (not shown) to allow for forensic analysis using a virtual forensic tool.

In addition, the processor controller 314 of the extendable forensic server system 310 may drive the image generation unit 315, the analyzing unit 316, and the searching unit 317 by using resources of a lab/distributed system 320 which can be connected to the extendable forensic server system 310 via a local network or a wide area network.

In detail, the image generation unit 315, the analyzing unit 316, and the searching unit 317 may be modularized into an executable state such as a thread, a process, or the like, and the process controller 314 mounts a module currently required for forensic in the lab/distributed system 320 to process demands from the remote terminal 240.

In this case, as the lab/distributed system 320, an available system existing in various distributed system environment, a grid environment, a cloud computing environment, and the like, as well as a local system within a forensic analysis center, may be applied.

Also, such function may be provided by the process controller 222 of the forensic analysis system 220, as well as by the processor controller 314 of the forensic analysis system 220.

In this manner, in an exemplary embodiment of the present invention, the image generation unit 315, the analyzing unit 316, and the searching unit 317 modularized by function are driven by using various resources existing in the local or the wide area network, thus increasing scalability of the forensic system and improving a processing rate, the most important issue of the forensic requirement.

The network-based remote forensic system according to an exemplary embodiment of the present invention is not limited to the foregoing configuration and can be modified to have any configuration within the scope of the technical concept of the present invention. Also, various protocols, such as a Web protocol of HTTP, or the like, a TCP, a UDP, and the like, may be used to use a network.

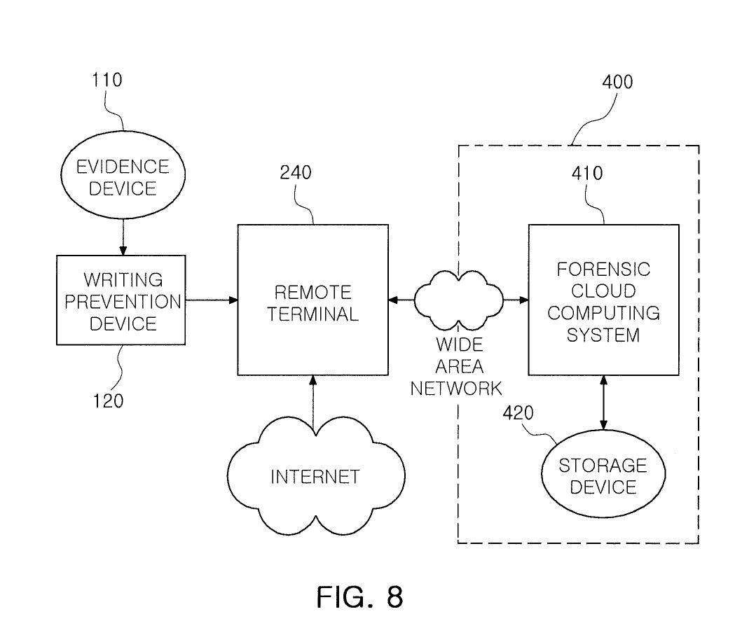

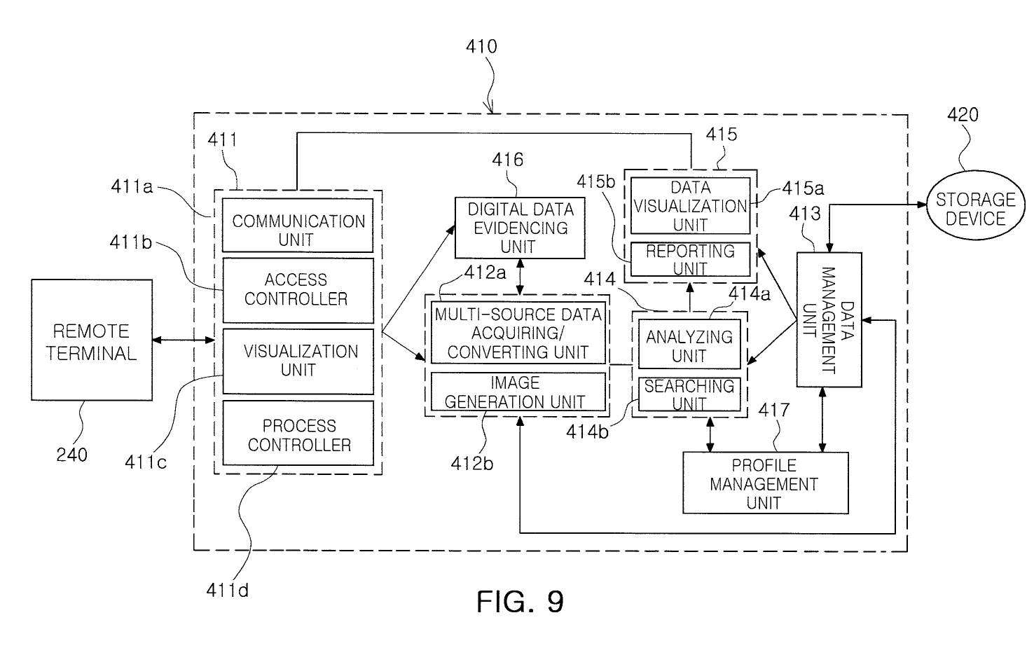

FIGS. 8 and 9 are schematic block diagrams of a network-based remote forensic system according to another exemplary embodiment of the present invention.

First, with reference to FIG. 8, an investigation center system 400 may include a forensic cloud computing system 410, a storage device 420, or the like, in order to provide a digital forensic service in a cloud computing manner. The forensic cloud system 410 has such a configuration that the extendable forensic server system 310 is operated on a cloud computing platform supporting distributed/parallel processing.

As shown in FIG. 9, the forensic cloud system 410 may include a server function unit 411, a data input unit 412, a data management unit 413, a data processing unit 414, a data output unit 415, a digital data evidencing unit 416, a profile management unit 417, and the like.

The server function unit 411 includes a communication unit 411a, an access controller 411b, a visualization unit 411c and a process controller 411d. The server function unit 411 supports communication with the remote terminal 240 and provides a virtual forensic tool to the remote terminal 240.

The communication unit 411a supports various communication protocols with a wired/wireless network, and the access controller 411b performs an authentication and access right allocation operation on the remote terminal 240.

The visualization unit 411c serves to support protocols with various remote terminals 240. For example, in the case of a smartphone, the visualization unit 411c proposes an application provider and provides an application to allow the smartphone to receive a forensic cloud service, and when a terminal such as a PC, or the like, is connected by using a Web protocol, the visualization unit 411c provides a servlet to provide a virtualized environment allowing for the use of a forensic cloud service. Namely, the visualization unit 411c provides a user environment fitting an access protocol with the remote terminal 240.

The process controller 411d serves to control various processes to provide a service.

The data input unit 412 includes a multi-source data acquiring/converting unit 412a and an image generation unit 412b. The data input unit 412 converts a data format of multi-source data into an internal format and generates a forensic image. The multisource data acquiring/converting unit 412a collects data transmitted from multiple sources such as a Web mail, a database query, a temporary data, and the like, and standardizes the collected data into the internal format. The image generation unit 412b generates a forensic image with respect to output data from the multi-source data acquiring/converting unit 412a.

The data management unit 413 stores output data from the data processing unit 414 in the storage device 420 or provides the same to the data output unit 415. Also, the data management unit 413 provides the data stored in the storage device 420 to the data processing unit 414 and the data output unit 415. The data stored in the storage device 420 may have various formats such as raw data, an image format, or a format predefined for a service, or the like, according to a management policy of the forensic cloud system 410.

The data processing unit 414 may include a searching unit 414a and an analyzing unit 414b. The data processing unit 414 may perform evidence searching and analyzing on the forensic image according to a request from the remote terminal 240.

The searching unit 414a performs evidence searching on the forensic image in response to the request message from the remote terminal 240, and the analyzing unit 414b performs evidence analyzing on the forensic image in response to the request message from the remote terminal 240.

In the evidence searching method, evidence searching is performed by using an output from the data input unit 412, and in this case, various searching methods such as searching by bit stream or by file, index searching, searching of a deleted file and a lost file, may be applied to perform evidence searching. As the evidence analyzing method, various methods, such as a statistics analysis, a timeline analysis, a connection analysis, and the like, besides a registry analysis, an e-mail account analysis, a hidden area analysis, for various storage devices, such as a physical memory, a solid state drive (SSD), and the like, as well as a hard disk drive, may be applied.

The data output unit 415 includes a data visualization unit 415a and a reporting unit 415b. The data output unit 415 provides forensic results in the form of visualized data or a report. The data visualization unit 415a provides the operation results of the data processing unit 414 as visualized data and the reporting unit 415b provides the operation results of the data processing unit 414 in the form of a report to the remote terminal 240 and/or to the data management unit 413.

The digital data evidencing unit 416 performs notarization on the evidence data and the analysis results report acquired by the remote terminal 240 and the analyzing unit 414b to thus perform evidencing on the data within the system. Namely, the digital data evidencing unit 416 adds a signature of a forensic cloud service or an officially recognized authentication institution to a digital document to be submitted to thus verify that the corresponding submission content has not been forged or falsified, so that the evidence data and the analysis results report can be adopted as evidence. The submission digital document generated thusly may be immediately transmitted to a submission organization such as an electronic court, or the like, via the communication unit 411a, or the like, through a network.

Besides the foregoing functions, if necessary, the forensic cloud system 410 may include various other required functions in order to perform forensic.

For example, in order to provide an automated analysis function based on a profile, the forensic cloud system 410 may additionally include the profile management unit 417. The profile management unit 417 will be described later.

The forensic cloud system 410 is operated on cloud computing platform supporting distributed/parallel processing, rather than on a window-based single platform. Thus, each user does not need to endeavor to operate and manage a forensic tool, and a plurality of users may be simultaneously connected to the forensic cloud system 410 in order to use a service. Thus, the utilization of the system and data can be improved.

Also, because system scalability in terms of cloud computing is high, the performance thereof can be easily enhanced as necessary.

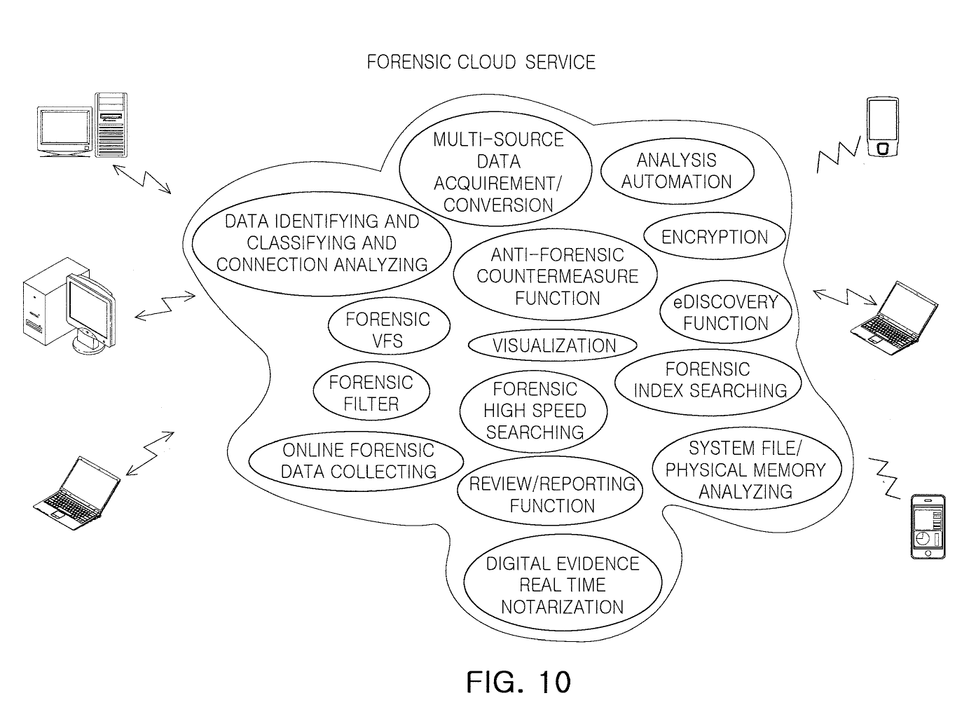

FIG. 10 is a view showing the concept of a forensic cloud service provided by the network-based remote forensic system according to another exemplary embodiment of the present invention.

All of the functions provided by the network-based remote forensic system are provided by the forensic cloud, and the users may be connected to the cloud by using various types of remote terminals 240 and request a desired forensic function. Then, the performing results are displayed through the terminals.

Also, the remote terminal 240 may directly acquire a Web data/e-mail or secure data acquired from various sources, such as a DB query, a temporarily stored data, and the like, and transmit the same to the forensic cloud system.

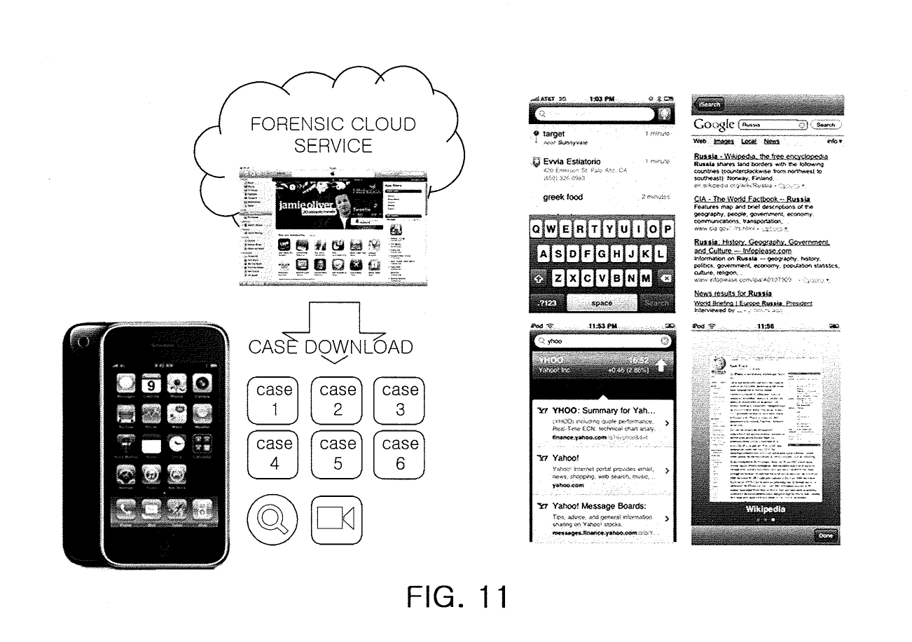

FIG. 11 is a view showing the example of a configuration and operation of the network-based remote forensic system according to another exemplary embodiment of the present invention.

The user may be connected to a case provider (e.g., in the form of Apple's Appstore) provided by the forensic cloud by using the remote terminal 240 such as a smartphone, a notebook, and the like, undergoes a user authentication process, searches for a required case, and downloads the corresponding case by his remote terminal 240.

One case may be defined by data and a GUI-based application including a function of analyzing or reviewing the corresponding data.

In order to strengthen security, the forensic cloud service may set a function allowing the user to use each case according to authority allowed for the user, limit a data range allowed for the user, or set a usage period, before the user downloads each case.

The data management unit 413 may generate a new case by using data collected in the storage device 420 or directly collected data according to a user request. Namely, the user may generate a new case by using data collected in the storage device 420 or directly collected data by using a data management application provided by the forensic cloud.

Also, two or more cases may be merged, or a portion of a case may be extracted as a new case.

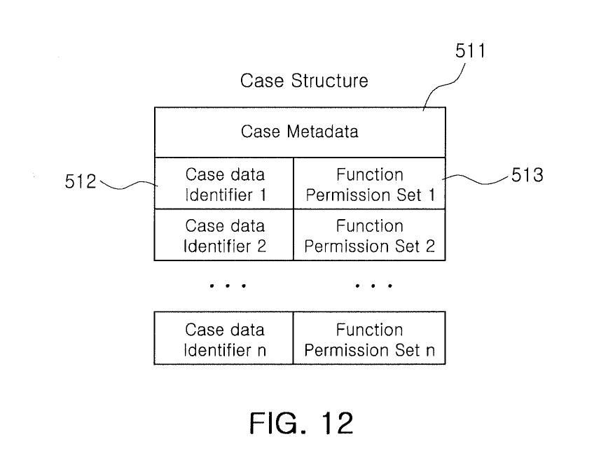

FIG. 12 is a view showing a case structure according to an exemplary embodiment of the present invention.

The case structure includes three areas: a meta data area (Case Metadata) 511 for indicating a case name, a generation date/time, a generator, or the like, a case data identifier 512 identifying a position of data such as a path of data or a data set, a physical address, a URI, or the like, and a function permission set 513 defining a function performed for each data or each data set within an applied range.

Referring to the function permission set area 513, like it is set in a mode such as 777 when reading, writing, and execution are available in a file permission set of Unix, various functions for performing forensic analysis may be defined, and the function permission set area 513 may be represented by a combination of a defined function and its permission.

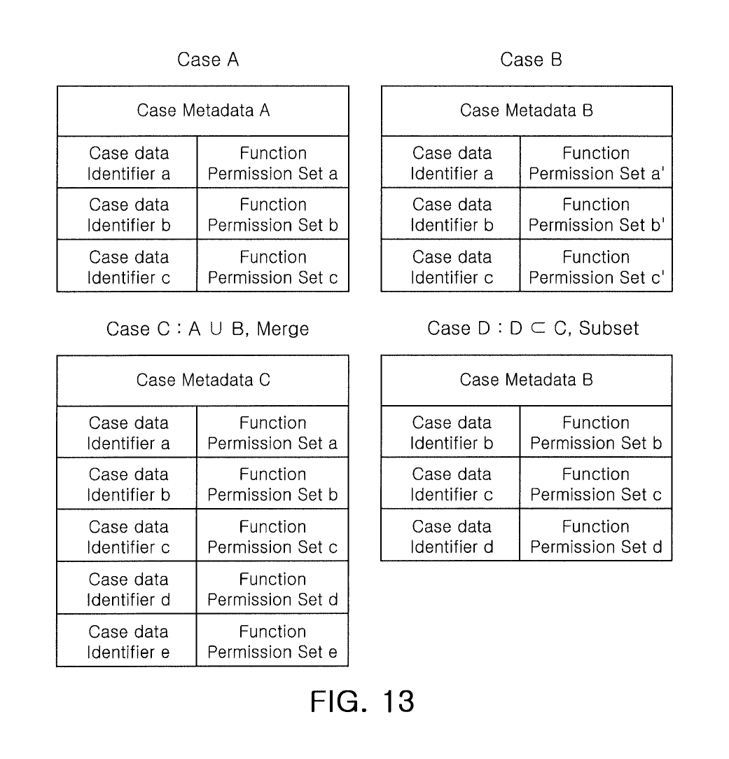

When two or more cases are merged, it can be represented as union of the two cases as shown in FIG. 13, and a function permission set, set for common data, may be reset according to policy.

When a portion of a case is extracted as a new case, the new case can be easily configured as shown in FIG. 13. Besides, various operations may be provided as necessary.

Also, when a case is selected, an automated analysis function based on a profile may be provided through the profile management unit 417. The profile is obtained by defining content/keywords to be analyzed for each case category based on investigation know-how.

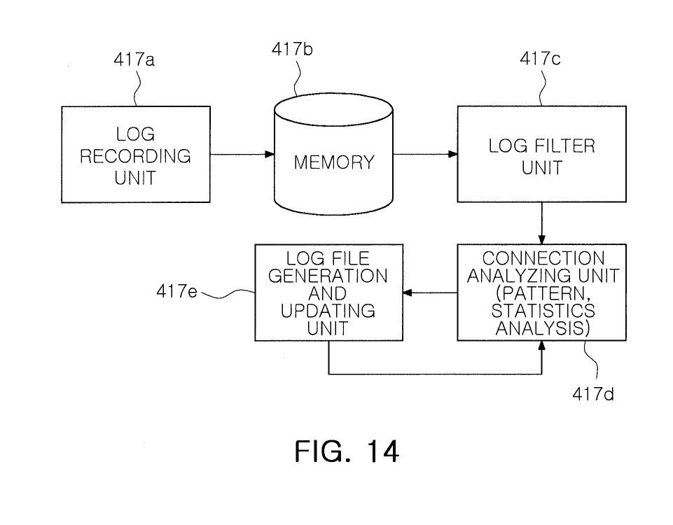

FIG. 14 is a detailed block diagram of a profile management unit according to another exemplary embodiment of the present invention.

With reference to FIG. 14, a profile management unit 417 may include a log recording unit 417a, a memory 417b, a log filter unit 417c, a connection analyzing unit 417d, and a profile generating and updating unit 417e.

First, when the user is connected to the forensic cloud service, the log recording unit 417a, configured to record a user's log, operates to record a user's action in a memory.

The log filter unit 417c maps a case category and the corresponding user's log and selects only a valid log (namely, it removes an unnecessary log), and the connection analyzing unit 417d extracts a word frequently searched by case, frequently analyzed data by case, frequently used function by case, and an analysis pattern of each case from the valid log.

The profile generating and updating unit 417e recognizes a connection between the case categories with reference to the previously generated profile, and generates or updates the profile with respect to the corresponding case categories.

Various methods, such as statistics analysis, artificial intelligence-wise learning, data mining, and the like, may be applied in order to perform the foregoing extraction and connection analysis.

Thus, in an exemplary embodiment of the present invention, when the user requests forensic using a profile, results obtained by performing automated analysis according to the method and procedure defined in the profile may be provided in various forms, such as in the form of a report, or the like, or analyzing may be performed in advance during a system idle time, the corresponding results may be stored, and thereafter, the results may be provided upon receiving a corresponding request.

As set forth above, according to exemplary embodiments of the invention, because the network-based remote forensic system allows any qualified person to access a forensic analysis center via a network to perform forensic analysis at any time and in any place, as well as in an investigation spot, the cost otherwise caused by a physical distance can be reduced, the utilization of an established forensic system can be increased, collected evidence data can be accumulated and easily used as necessary, thereby increasing a work efficiency.

In addition, because the network-based remote forensic system allows for an access to a distributed environment, a grid environment, a cloud computer environment, or the like, to utilize available resources to its maximum level, and processing capacity and speed can be flexibly increased.

While the present invention has been shown and described in connection with the exemplary embodiments, it will be apparent to those skilled in the art that modifications and variations can be made without departing from the spirit and scope of the invention as defined by the appended claims.

What is claimed is:

1. A network-based remote forensic system comprising:
one or more remote terminals performing forensic analysis on an evidence device in a remote area, through a virtual forensic tool when the evidence device is connected thereto; and
an investigation center system connected to the remote terminals via a wide area network to provide the virtual forensic tool, processing a requirement of the remote terminals, and providing requirement processing results to the remote terminals.

2. The system of claim 1, wherein the investigation center system comprises:
a forensic analysis system processing the requirement of the remote terminals and outputting the requirement processing results; and
a forensic server system providing the virtual forensic tool to the remote terminals and relaying data communication between the remote terminals and the forensic analysis system.

3. The system of claim 2, wherein the forensic server system comprises:
a communication unit supporting the connection between the remote terminals and the forensic analysis system and data communication;
an access controller controlling an access right of the remote terminals;
a virtualization unit providing the virtual forensic tool only when the remote terminals have an access right; and
a processor controller supporting multiple accessing of the remote terminals.

4. The system of claim 3, wherein the virtualization unit comprises:
a visualization module visualizing a user interface supporting forensic analysis and the forensic processing results and providing the same; and
a virtual file system module parsing and managing the structure of a file system included in a forensic image.

5. The system of claim 2, wherein the forensic analysis system comprises:
a communication unit supporting a connection to the forensic server system and data communication;
an image generation unit generating a forensic image by using a data stream from the remote terminals transmitted through the forensic server system, and storing the same;
an analyzing unit analyzing a piece of evidence by using the forensic image;
a searching unit performing evidence searching by using the forensic image; and
a process controller controlling the operation of the image generation unit, the analyzing unit, and the searching unit according to a request message from the remote terminals transmitted via the forensic server system, and transmitting the control results to the remote terminals via the forensic server system.

6. The system of claim 2, wherein the investigation center system comprises:
an extendable forensic server system connected to the remote terminals to provide the virtual forensic tool, processing a requirement of the remote terminals, and providing requirement processing results to the remote terminals; and
a lab/distributed system providing resources required for the operation of the extendible forensic server system.

7. The system of claim 6, wherein the extendible forensic server system comprises:
a communication unit supporting a connection to the remote terminals and data communication;
an access controller controlling an access right of the remote terminals;
a virtualization unit providing the virtual forensic tool only when the remote terminals have an access right;
an image generation unit generating a forensic image by using a data stream from the remote terminals and storing the same;
an analyzing unit analyzing a piece of evidence by using the forensic image;
a searching unit performing evidence searching by using the forensic image; and
a process controller controlling the operation of the image generation unit, the analyzing unit, and the searching unit according to a request message from the remote terminals, and transmitting the control results to the remote terminals.

8. The system of claim 6, wherein the extendible forensic server system comprises:
a server function unit supporting communication with the remote terminals, and providing the virtual forensic tool to the remote terminals;
a data input unit converting a data format of multi-source data into an internal format and generating a forensic image;
a data processing unit performing evidence searching and analyzing on the forensic image according to a request from the remote terminals;
a data output unit providing processing results of the data processing unit to the remote terminals;
a data management unit storing data in a storage device or reading the data under the control of the data processing unit and the data output unit; and
a digital data evidencing unit performing evidencing on the data input from the remote terminals and data provided from the remote terminals.

9. The system of claim 8, wherein the extendible forensic server system provides a forensic service in a cloud computing manner.

10. The system of claim 8, wherein the server function unit comprises:
a communication unit supporting a connection to the remote terminals and data communication;
an access controller controlling an access right of the remote terminals;
a virtualization unit providing the virtual forensic tool only when the remote terminals have an access right; and
a processor controller supporting multiple accessing of the remote terminals.

11. The system of claim 8, wherein the data input unit comprises:
a multi-source data acquiring/converting unit standardizing a data format of input data having multiple sources into an internal format; and
an image generation unit generating a forensic image with respect to an output from the multi-source data acquiring/converting unit.

12. The system of claim 8, wherein the data output unit comprises:
a data visualization unit providing operation results of the data processing unit, as visualized data; and
a reporting unit providing the operation results of the data processing unit in the form of a report.

13. The system of claim 8, wherein the extendible forensic server system further comprises: a profile management unit managing and providing a profile with respect to a category of each case.

14. The system of claim 8, wherein the profile management unit comprises:
a log recording unit recording a user log in a memory;
a log filter unit mapping a case category to the user log and selecting only a valid log;
a connection analyzing unit extracting an analysis pattern of each function and case from the valid log and analyzing their connection; and
a profile generating and updating unit generating or updating a profile with respect to a category of each case according to the results of the connection analysis.

15. The system of claim 8, wherein the data management unit may further have a function of merging two or more cases or a portion of a case as a new case by using the data stored in the storage device.

16. The system of claim 15, wherein the case comprises:
a meta data area in which one or more of a case name, a generation date/time, a generator are indicated;
a case data identifying area in which one or more of the path of data or a data set, a physical address, and a URI are indicated; and
a function permission set area defining a function that can be performed with respect to the data or the data set within an applied range.

17. The system of claim 15, wherein the case is provided to the remote terminals according to a forensic cloud service method.
